(19) United States
(12) Patent Application Publication
(10) Pub. No.: US 2022/0071317 A1
(43) Pub. Date: Mar. 10, 2022

(54) FACE MASK WITH EMBEDDED TECHNOLOGY

(71) Applicant: Charles Isgar, Scottsdale, AZ (US)

(72) Inventor: Charles Isgar, Scottsdale, AZ (US)

(21) Appl. No.: 17/017,572

(22) Filed: Sep. 10, 2020

(51) Int. Cl. A41D 13/11; A42B 3/04; A42B 3/30

(52) U.S. Cl. CPC A41D 13/11; A62B 18/02; A42B 3/30; A42B 3/0433

(57) ABSTRACT

A face mask with embedded technology is provided. The face mask may include a face covering portion with attachment members. The attachment members are configured to secure the face covering portion to a face of a wearer. Technology may be embedded within the face covering portion, wherein the embedded technology enhances human expression of the wearer. The embedded technology may be a digital screen with a micro controller, a speaker with a micro controller, an air intake sensor, a visual element, a GPS device, a timer, or the like. Further, in some embodiments, the embedded technology is coupled to a user computing device, wherein the user computing device operates to provide additional control of the embedded technology.

### BACKGROUND OF THE INVENTION

### Technical Field

This invention relates generally to a face mask, and more particularly to a face mask with embedded technology for enhancing human expression.

### State of the Art

The human population at various times may have a need to wear face masks for health reasons and for other purposes. A drawback of widespread use of face masks, includes limiting human expression, such as, but not limited to, limiting facial expressions, limiting volume of speech, and the like. There is not a face mask that is capable to address such drawbacks.

Accordingly, there is a need for a face mask with embedded technology that can enhance human expression among other advances that may be provided by use of such a face mask with embedded technology.

### DISCLOSURE OF THE INVENTION

The present invention relates to a face mask with embedded technology that can enhance human expression among other advances that may be provided by use of such a face mask with embedded technology.

An embodiment includes a face mask comprising a face covering portion with attachment members, wherein the attachment members are configured to secure the face covering portion to a face of a wearer; and technology embedded with the face covering portion, wherein the embedded technology enhances human expression of the wearer. The embedded technology may be a digital screen with a micro controller, a speaker with a micro controller, an air intake sensor, a visual element, a GPS device, a timer, or the like. Further, in some embodiments, the embedded technology is coupled to a user computing device, wherein the user computing device operates to provide additional control of the embedded technology.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a face mask with embedded technology and optional components of a system utilizing the face mark with the embedded technology in accordance with an embodiment;

FIG. 2 is a view of a face mask with embedded technology in accordance with an embodiment;

FIG. 3 is a view of various human facial expressions that may be used with embedded technology in accordance with an embodiment;

FIG. 4 is a view of a face mask with embedded technology in accordance with an embodiment;

FIG. 5 is a view of a face mask with embedded technology in accordance with an embodiment;

FIG. 6 is a view of a face mask with embedded technology in accordance with an embodiment;

FIG. 7A is a view of a face mask with embedded technology in accordance with an embodiment;

FIG. 7B is a view of a face mask with embedded technology in accordance with an embodiment;

FIG. 8 is a view of a face mask with embedded technology in accordance with an embodiment;

FIG. 9 is a view of a user computing device depicting GPS data of a face mask with embedded technology in accordance with an embodiment;

FIG. 10 is a view of a user computing device depicting timer data of a face mask with embedded technology in accordance with an embodiment;

FIG. 11 is a view of a face mask with embedded technology in accordance with an embodiment;

FIG. 12 is a view of a face mask with embedded technology in accordance with an embodiment; and

FIG. 13 is a view of a face mask with embedded technology in accordance with an embodiment.

### DETAILED DESCRIPTION OF EMBODIMENTS OF THE INVENTION

As discussed above, embodiments of the present invention relate to a face mask with embedded technology that can enhance human expression among other advances that may be provided by use of such a face mask with embedded technology.

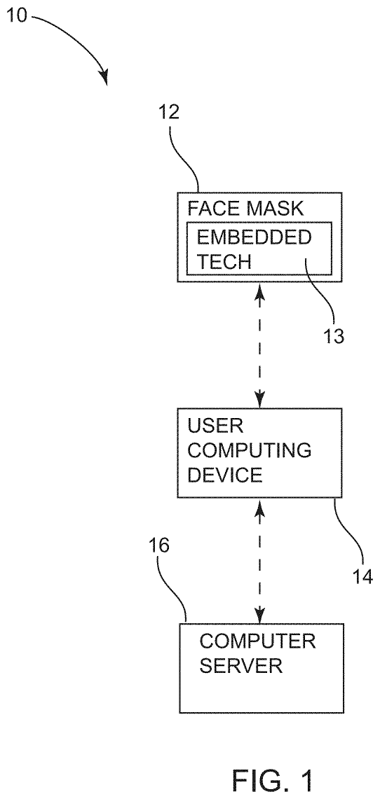

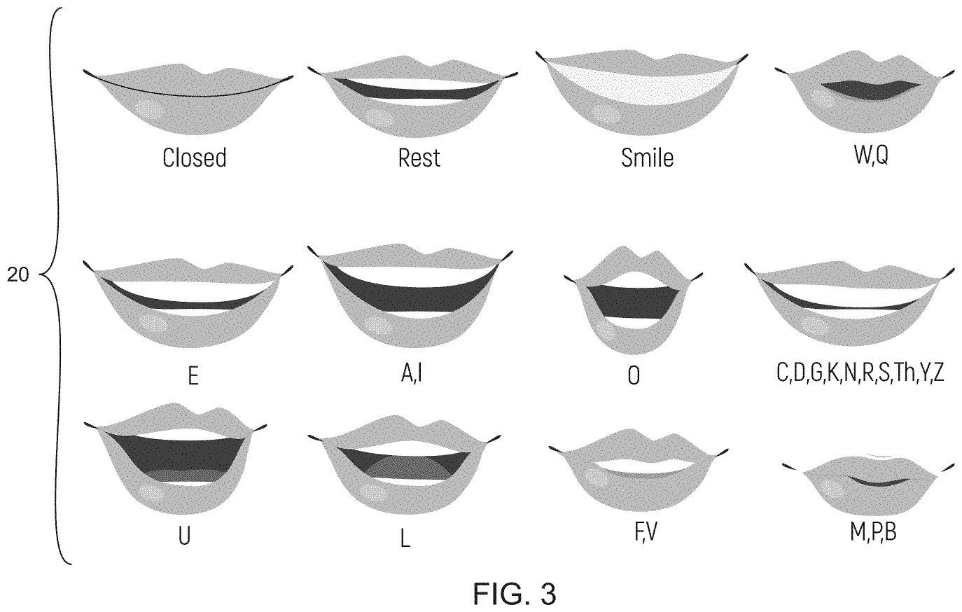

Referring to the drawings, FIG. 1 depicts an embodiment of a system 10 that includes a face mask 12 with embedded technology 13, and optionally a user computing device 14, and a computer server 16. The embedded technology 13 embedded in the face mask 12 may be coupled to the user computing device 14, and the user computing device 14 may also be coupled to the computer server 16. The coupling between the embedded technology 13 and the user computing device may be a wireless connection, such as, but not limited to a Bluetooth connection, a WiFi connection or the like for transmission of communication between the embedded technology 13 and the user computing device 14. The coupling between the user computing device and the server 16 may be a network connection, such as through an Internet connection, wherein the user computing device 14 may communicate with and receive communication from the server 16. Referring to FIGS. 3-8, the face mask 12 may include a face covering portion 11 with attachment members 15, the technology 13 being embedded in the face covering portion 11. In some embodiments, the technology 13 may be embedded in the attachment members 15.

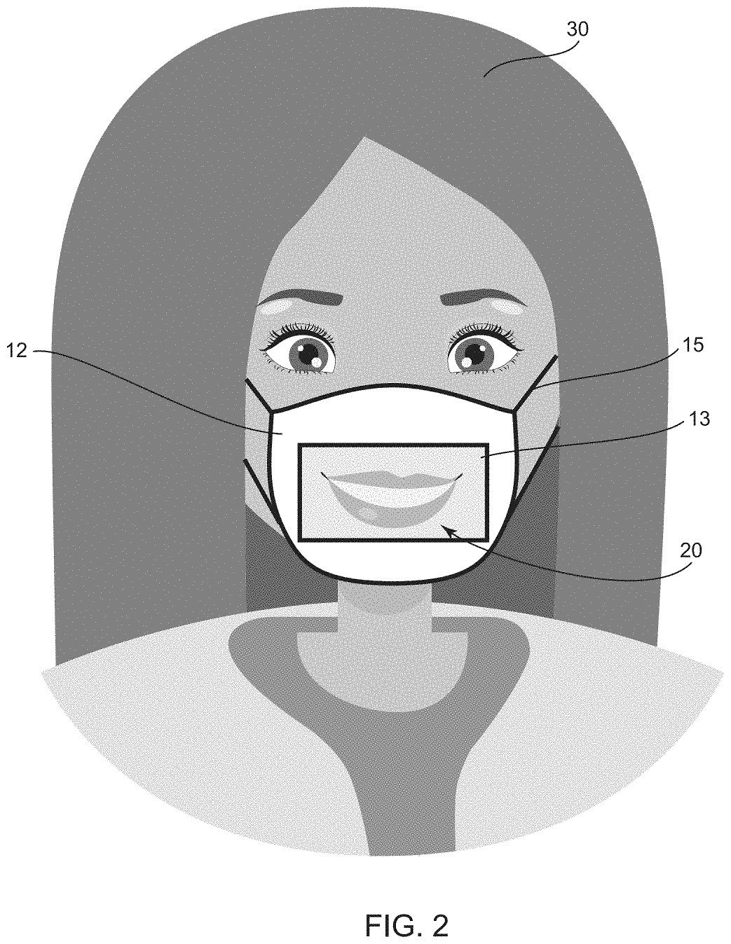

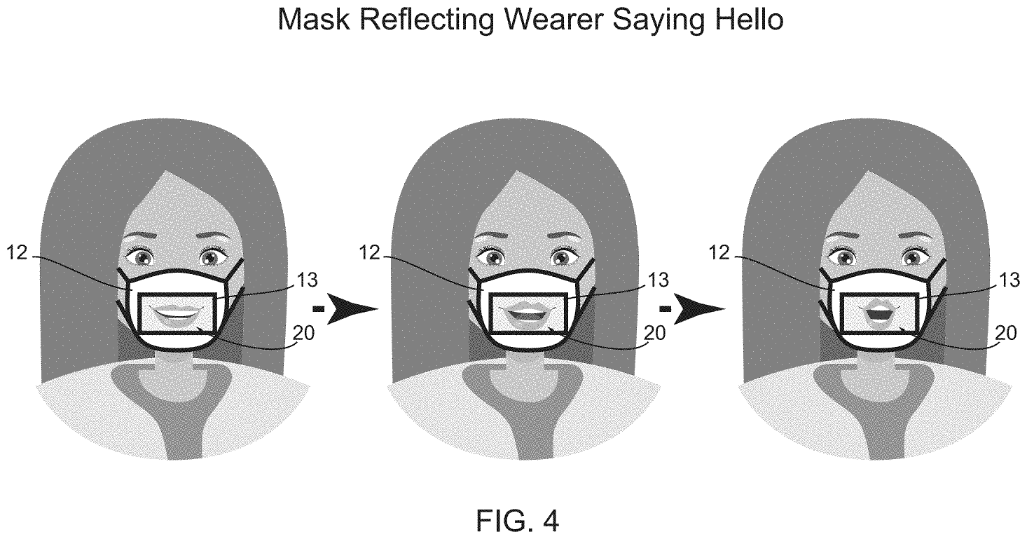

Referring to FIGS. 2-4, embodiments of a face mask 12 with embedded technology 13 as worn by user 30 is depicted. In these embodiments, the embedded technology 13 is a digital screen with a microcontroller. The digital screen may be a flexible screen and may include a shape that corresponds to the shape of the face mask 12, or the digital screen may be integrated OLED (organic light-emitting diode) into fabrics. The microcontroller operates the screen and provides the programming necessary to depict various facial expressions 20 on the screen. In some embodiments, the embedded technology 13 of the digital screen may also include sensors or a camera that can operate to determine the movements of the mouth of the wearer of the mask and communicate with the microcontroller such that the microcontroller is programmed to send for display on the digital display embedded in the mask 12 a depiction of a similar mouth expression of the user behind the mask. Some non-limiting examples of mouth expressions are depicted in FIG. 3. For example, there may be mouth expressions for a closed mouth, a resting mouth, a smile, or the like. Additionally, there may be mouth expressions for various sounds a human would make during speaking that align with certain letter and combinations thereof, such as, but not limited to, W, Q; E; A, I; O; C, D, G, K, N, R, S, Th, Y, Z; U; L; F, V; M, B, P; or the like. This may include sensing and displaying changes in mouth expression during talking as shown in FIG. 4 depicting a wearer of a mask 12 wherein the embedded screen depicts a mouth transitioning between various mouth expressions in an animation of a mouth speaking, such as speaking the word “hello” with the screen mimicking the expression of the mouth of the user hidden behind the mask. This may be accomplished by the sensors or camera determining the mouth movements and copying such. It may also be an audio sensor, wherein the screen depicts movements based on the sounds being spoken by the wearer. In some embodiments, the embedded technology 13 that is a digital screen with a microcontroller may be coupled to a user computing device 14, the user computing device may communicate with the microcontroller to send expressions to depict on the screen forming a system of component that operate to control the mouth expressions being depicted on the screen embedded in the mask.

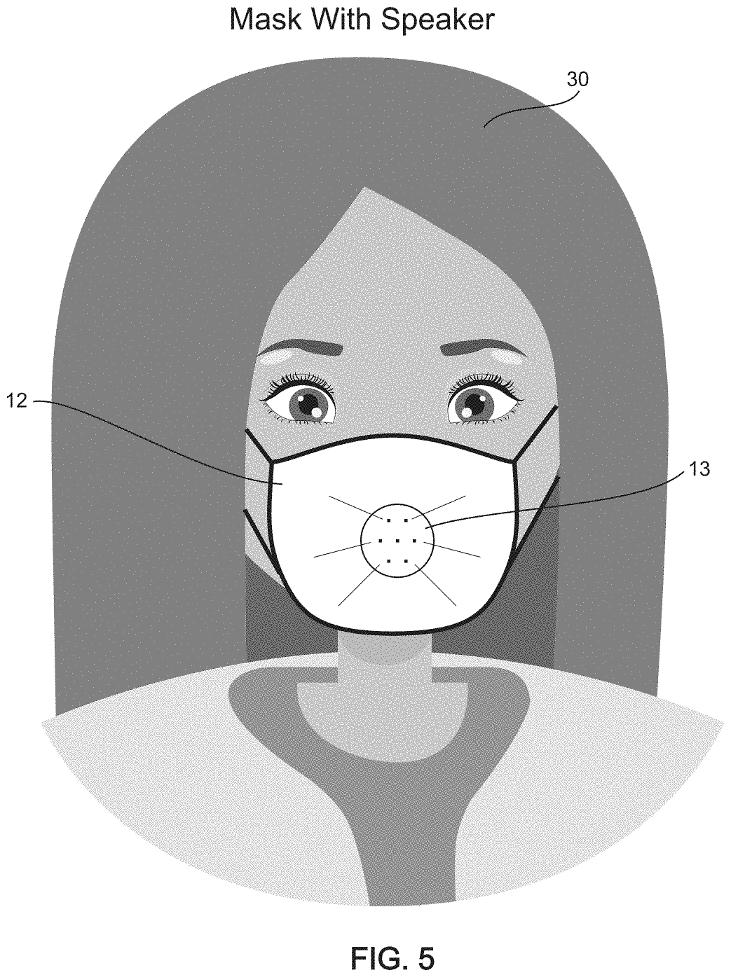

Referring to FIG. 5, embodiments of the face mask 12 may comprise embedded technology 13 that is a speaker with a microcontroller. The speaker may operate to amplify the voice of the speaker to more clearly project the voice of the wearer of the mask 12 to those she may be speaking to. The microcontroller may include a microphone for receiving the audio spoken by the wearer, process the audio and sending a processed signal to the speakers at a user selected amplification. In some embodiments, the embedded technology 13 that is a speaker with a microcontroller may be coupled to a user computing device 14, wherein the user computing device 14 and the microcontroller communicate, such that the microcontroller sends the audio received through the microphone to the user computing device 14 for processing and sends a signal to the microcontroller with the processed signal at the user selected amplification to be played through the speaker, thereby forming a system of components that operate to control the volume of the wearers voice embedded in the mask. Further still, in come embodiments, the user may utilize the user computing device 14 to send predetermined content in a voice form from the user computing device of the microcontroller of the speaker for playing through the speaker, thereby allowing the wearer to communicate without actually having to speak.

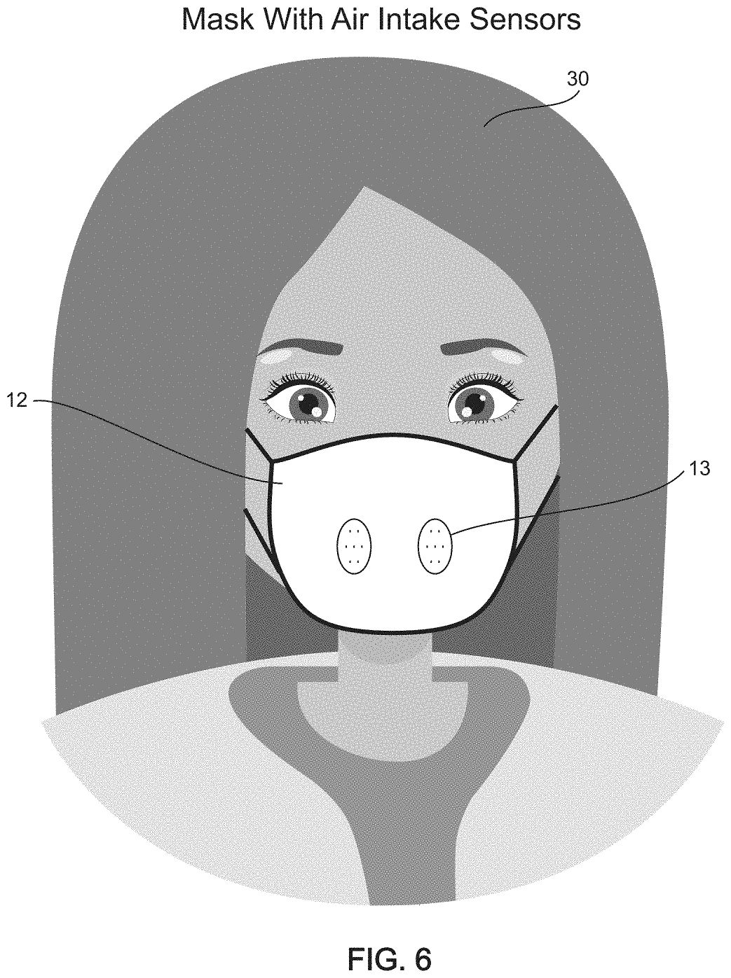

Referring to FIG. 6, embodiments of the face mask 12 may comprise embedded technology 13 that is an air intake sensor. The air intake sensor may include a microcontroller that is in communication with the user computing device 14. The air intake sensor may monitor air intake of the wearer and send through the microcontroller to the user computing device 14 data regarding the air intake. This may include breathing rate, oxygen content of air intake, content of air expelled through the sensors, and the like. This data may be aggregated on the user computing device 14 and provide reports to the user regarding air intake. Further still, the user computing device 14 may be coupled to a server 16 and send the data from the air intake sensors to the server for aggregation. The data on the server 16 may then be used in reports that can be generated with or without user identifying information. It may provide analysis of quality of air or other issues that may be present when there is prolonged wearing of a face mask 12.

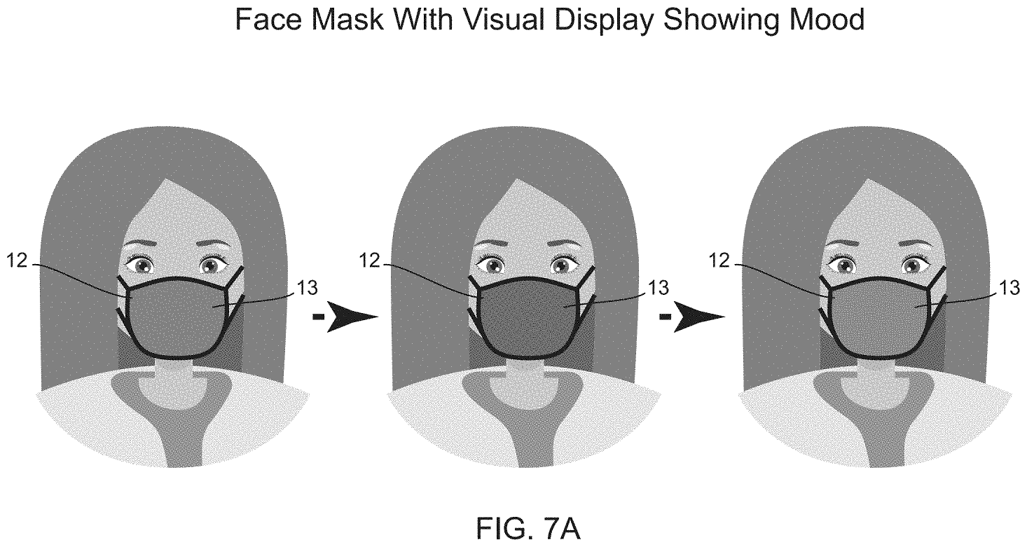

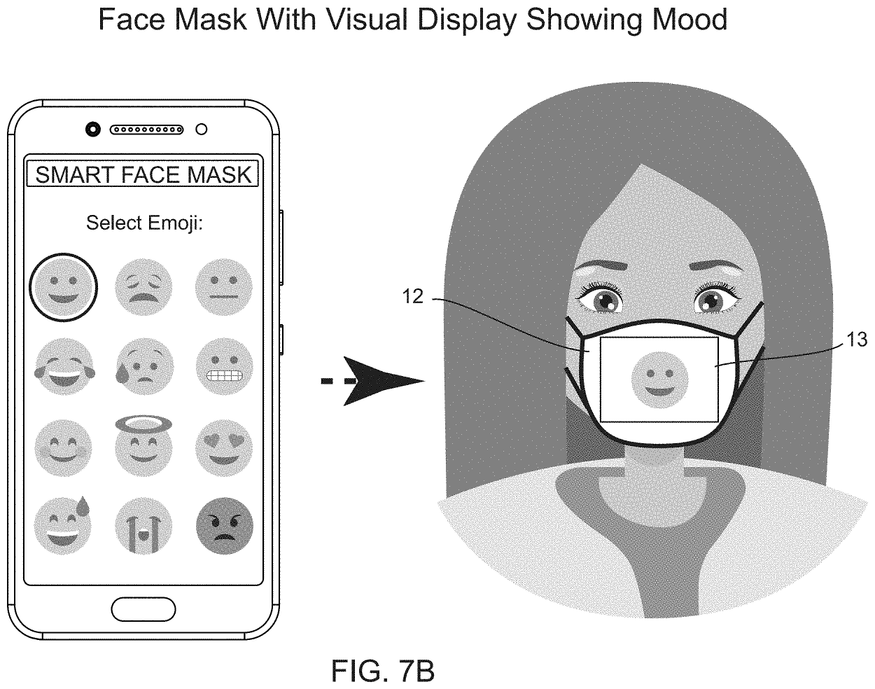

Referring to FIGS. 7A-7B, embodiments of the face mask 12 may comprise embedded technology 13 that is a visual element. The visual element may be a screen, an array of LEDs, or the like. The visual element may be a flexible screen and may include a shape that corresponds to the shape of the face mask 12, or the digital screen may be integrated OLED (organic light-emitting diode) into fabrics. The visual element may be coupled to a microcontroller with a sensor that can sense bio-readings, such as temperature. Based on the temperature of the wearer, the color displayed from the visual element may be changed. For example, body temperature may fluctuate based on the mood of the wearer and the color corresponds to the mood. As shown in FIG. 7A, the visual element may be red to correspond to nervous mood, may be green to correspond to being in an active mood, may be light blue to correspond to a relaxed mood or the like.

FIG. 7B depicts a system wherein the embedded technology 13 that is a visual element may be a screen. The visual element may be a flexible screen and may include a shape that corresponds to the shape of the face mask 12, or the digital screen may be integrated OLED (organic light-emitting diode) into fabrics. Further, the embedded technology 13 may include a microcontroller that is coupled to a user computing device 14. The user may select a particular emoji on the user computing device 14. The user computing device may then send instruction to the microcontroller of the embedded technology 13 to display the emoji selected by the user on the user computing device 14. In at least this way, the user may display an emoji that matches the mood she wishes to portray to others she engages with.

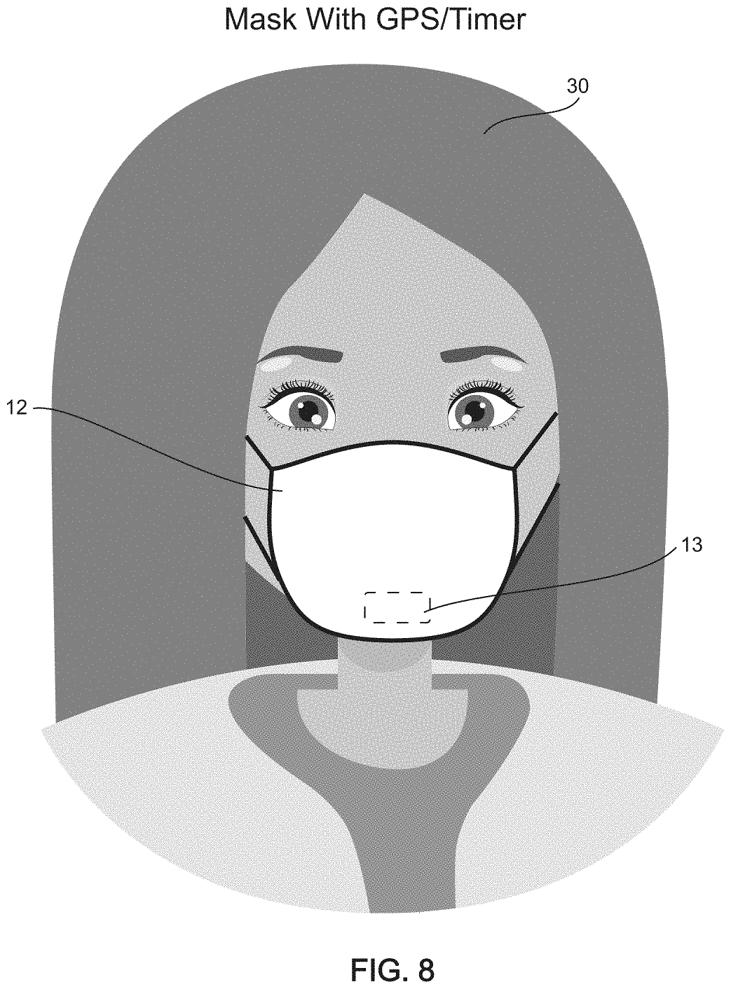

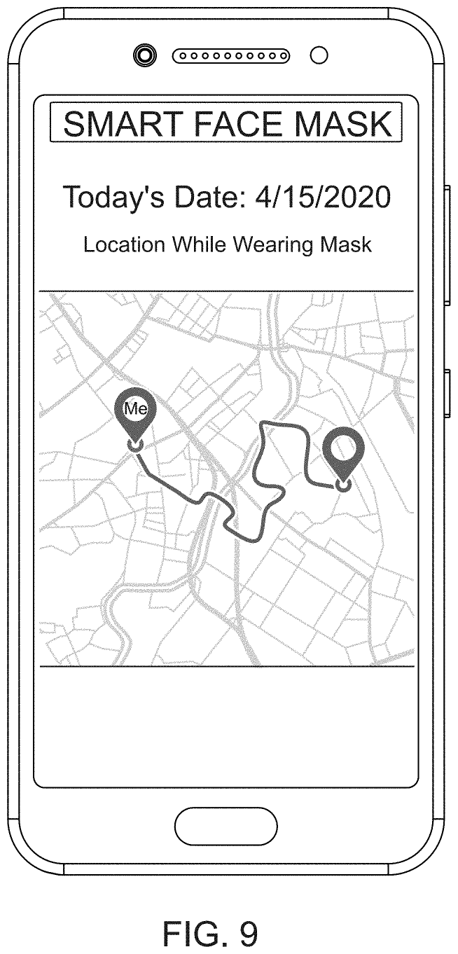

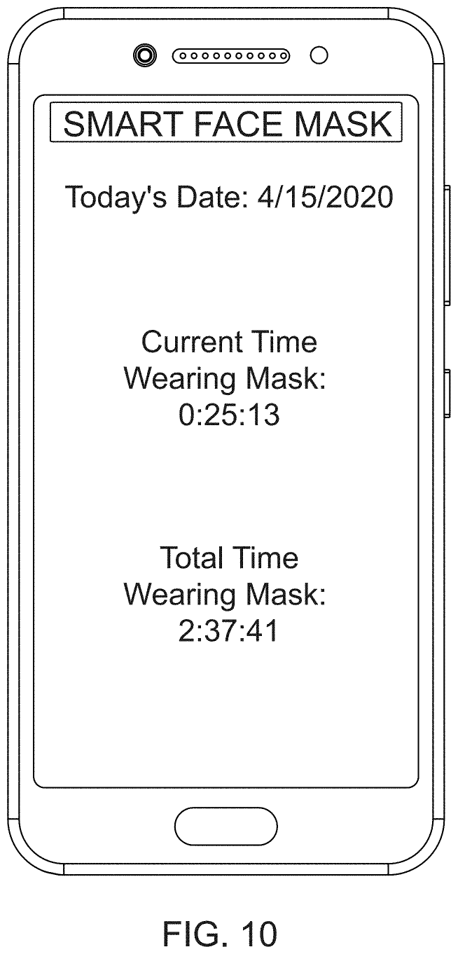

Referring to FIGS. 8-10, embodiments of the face mask 12 may comprise embedded technology 13 that is a GPS device or a timer. The GPS device or timer may include a microcontroller that is in communication with the user computing device 14. The GPS device or timer may monitor the location of the wearer when wearing the mask or the amount of time the wearer was wearing the mask and send location and time data. This data may be aggregated on the user computing device 14 and provide reports to the user regarding location tracking and/or time the mask was being worn as shown in FIGS. 9 and 10. Further still, the user computing device 14 may be coupled to a server 16 and send the data from the GPS device or the timer to the server for aggregation. The data on the server 16 may then be used in reports that can be generated with or without user identifying information. It may provide analysis of location and time of wearing of the mask of many users.

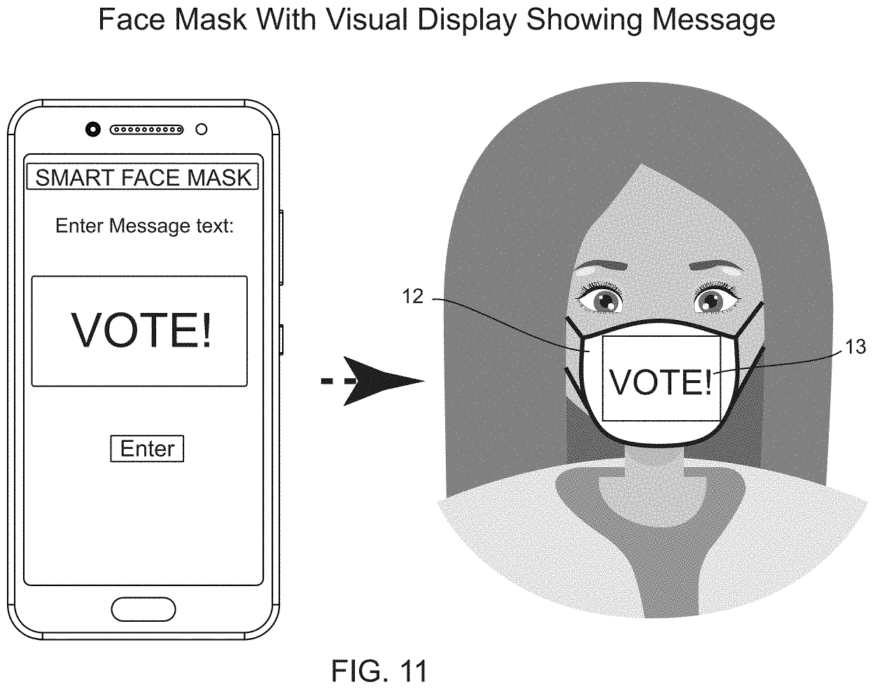

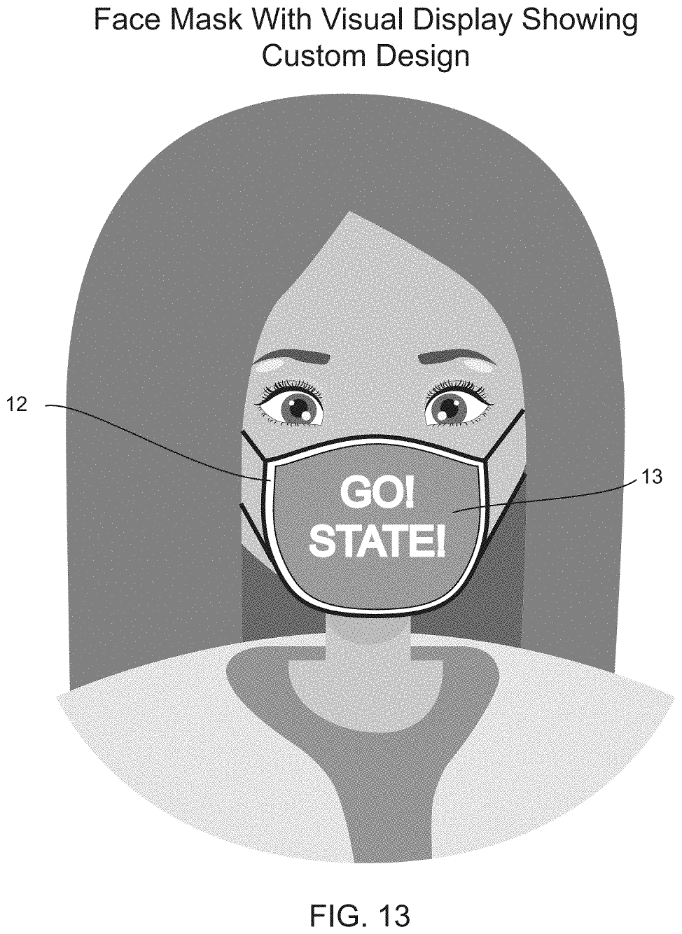

Referring again to the drawings, FIG. 11 depicts embodiments of the face mask 12 that may comprise embedded technology 13 that is a visual element, such as a screen. The visual element may be a flexible screen and may include a shape that corresponds to the shape of the face mask 12. Further, the embedded technology 13 may include a microcontroller that is coupled to a user computing device 14. The user may enter certain text and/or images/videos on the user computing device 14. The user computing device may then send instruction to the microcontroller of the embedded technology 13 to display the entered text and/or images/videos by the user on the user computing device 14. This allows the user to express her opinion or to promote or otherwise draw attention to something or some event, such as to vote as shown in FIG. 11. The face mask 12 and the user computing device 14 operate as a system to provide users the ability to control what message(s) she or he wishes to depict and publicly express. Another embodiment of this is depicted in FIG. 13, wherein the user has provided a color and reference to a university, such as the university colors and a cheer for her university like “GO! STATE!” as her personalized customized face mask 12 using embedded technology 13 to display the custom message and colors provided by the user through the user computing device.

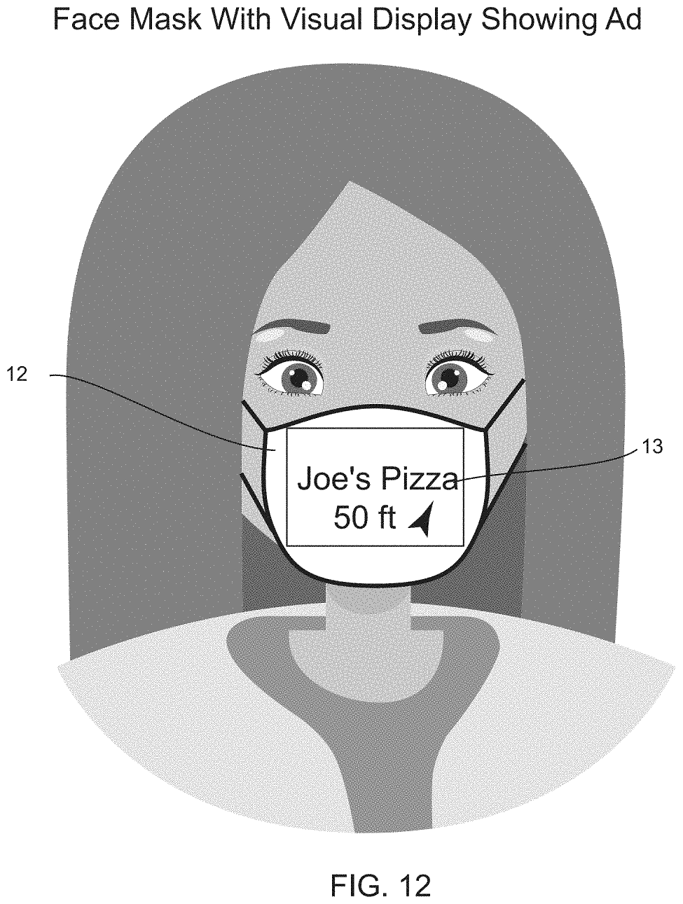

Referring again to the drawings, FIG. 12 depicts embodiments of the face mask 12 that may comprise embedded technology 13 that may be a visual element, such as a screen, that may be used as part of an advertisement system. The visual element may be a flexible screen and may include a shape that corresponds to the shape of the face mask 12. Further, the embedded technology 13 may include a microcontroller that is coupled to a user computing device 14, and the user computing device 14 in some embodiments may be coupled to a server 16. The face mask 12 may display an advertisement for a business. This advertisement may be determined based on the system displaying the advertisement for businesses that pay to have their advertisements displayed on masks. In some embodiments, this may occur on a rotational basis wherein one advertisement will be displayed for a first period of time, then another advertisement will be displayed for a second period of time and so forth for all advertisements that are to be displayed and then the cycle can start over. In other embodiments, as shown in FIG. 12, the advertisement may be geo location based wherein the location of the user may be determined by either a GPS device in the face mask 12 and communicated to the user computing device 14 or may be determined by a location device in the user computing device 14 carried by the user and coupled to the embedded technology 12. The server 16 may receive the location information from the user computing device 14 and determine what business or businesses are to have and advertisement shown on face masks 12 of users of the system. The server 16 may send instructions for execution along with advertisement content to the user computing device 14. The user computing device 14 may then send instruction to the microcontroller along with content to be displayed on the visual element functioning as the embedded technology 13. Because this advertisement is geo location based, it may provide directions to the business as shown in FIG. 12. In at least these ways, the face mask 12 with embedded technology 13 may be an advertisement system. It is contemplated that while this technology is shown as a face mask 12, other clothing may include embedded technology 13 such as a visual element, like a screen, that can operate to display advertisements.

Embodiments may be available on or through the internet, such as through domain names reserved and owned by Applicant that include maskedexpression.com, emoji-mask.com, maskedmood.com, masked-emotion.com or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A face mask comprising:
a face covering portion with attachment members, wherein the attachment members are configured to secure the face covering portion to a face of a wearer; and
technology embedded within the face covering portion, wherein the embedded technology enhances human expression of the wearer.

2. The face mask of claim 1, wherein the embedded technology is a digital screen with a micro controller.

3. The face mask of claim 1, wherein the embedded technology is a speaker with a micro controller.

4. The face mask of claim 1, wherein the embedded technology is an air intake sensor.

5. The face mask of claim 1, wherein the embedded technology is a GPS device.

6. The face mask of claim 1, wherein the embedded technology is a timer.

7. The face mask of claim 1, wherein the embedded technology is coupled to a user computing device, wherein the user computing device operates to provide additional control of the embedded technology.

8. The face mask of claim 1, wherein the embedded technology is a visual element.

9. A face mask system comprising:
a face mask comprising:
a face covering portion with attachment members, wherein the attachment members are configured to secure the face covering portion to a face of a wearer; and
technology embedded within the face covering portion, wherein the embedded technology comprises a visual element that enhances human expression of the wearer; and
a user computing device coupled to the embedded technology, wherein the user computing device sends instructions to the embedded technology to display user selected content on the visual element.

10. The face mask system of claim 9, wherein the embedded technology is a flexible digital display with a microcontroller.

11. The face mask system of claim 10, wherein the user selected content includes one of text, graphics, video or combinations thereof.
